(19) United States
(12) Patent Application Publication
(10) Pub. No.: US 2007/0265080 A1
(43) Pub. Date: Nov. 15, 2007

(54) Video game control device with speedy control key(s)

(76) Inventor: Alvin Yu, Yong He City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/430,005

(22) Filed: May 9, 2006

(51) Int. Cl. A63F 13/00

(52) U.S. Cl. 463/37

(57) ABSTRACT

A video game control device with speedy control keys is disclosed. The control device of the present invention comprises a control key set, at least one speedy control key and a connector. Either speedy control key is disposed on the right side or the left side of the front surface of the control device or the right side wall or the left side wall of the control device. Either speedy control key may be operated like a steering wheel. The functions of either speedy control key may be set through hardware or a software program. The speedy control keys can provide a plurality of functions so as to eliminate the need for other control devices and so that a user may play video games more easily.

### BACKGROUND OF THE INVENTION

1. Field of the Invention

The invention relates to a video game control device that at least one speedy control key is disposed on the right side or the left side on the front surface of the control device and that either speedy control key may be operated like a steering wheel. The functions of either speedy control key may be set through hardware or a software program. The speedy control keys can provide a plurality of functions so as to eliminate the need for other control devices and so that a user may play video games more easily.

2. Description of the Prior Art

There are various types of video/computer games, and each type of video/computer game has its own features and loyal players. Both software and hardware are needed so that we can enjoy a certain type of video/computer game. A well designed control device may help a player to play video games better; conversely, a poorly designed control device may make a video game less enjoyable.

Gamepad, which is a brand name of hand-held control device, has been quite popular because it may be used for most types of video games and there is no need for a player to purchase other control device.

However, with regard to car racing games, Gamepad is not a preferred choice because it does not have the functions of a steering wheel. Also, most players would not buy a steering wheel because a steering wheel is relatively large, is more expensive and may be used for only few types of video games. Hence, car racing games have become less popular.

It is quite important that a hand-held control device has an ergonomic design; otherwise, the use of a poorly designed control device would cause fatigue to a user. An ergonomically designed control device allows a user to use it comfortably and easily.

Many control devices available from the market are provided with several control keys. As illustrated in FIG. 1, though the control device 20 has a control key set 21, the control device 20 is not suitable to be used for a car racing game because it can not mimic a steering wheel.

To eliminate the disadvantages of the prior art control device, the inventor has put in a lot of effort in the subject and has successfully come up with the video game control device with speedy control key(s) of the present invention.

### SUMMARY OF THE INVENTION

An object of the present invention is to provide a video game control device with speedy control keys, whose functions may be set through hardware or software and which may be operated like a steering wheel and have an ergonomic design so as to allow a user to use the control device comfortably and easily.

Another object of the present invention is to provide a video game control device that may be used for video/computer games requiring a steering wheel and may eliminate the need to purchase additional software.

The video game control device with speedy control keys of the present invention has two speedy control keys disposed on the right side and the left side of the front surface of the control device. The functions of either speedy control key may be set through the hardware or software of the control device. Either speedy control key may be operated like a steering wheel so that the control device may be used for car racing games. Also, either speedy control key may return to its former position automatically so as to simplify the use of the two speedy control keys. With the control device of the present invention, a user only has to use one hand to play a car racing game. For example, while a user uses one of his hands to play a car racing game, he may use his other hand to hold a phone or do other thing.

### BRIEF DESCRIPTION OF THE DRAWINGS

The drawings disclose two illustrative embodiments of the present invention which serve to exemplify the various advantages and objects hereof, and are as follows:

FIG. 1 is a view schematically illustrating the video game control device of the prior art.

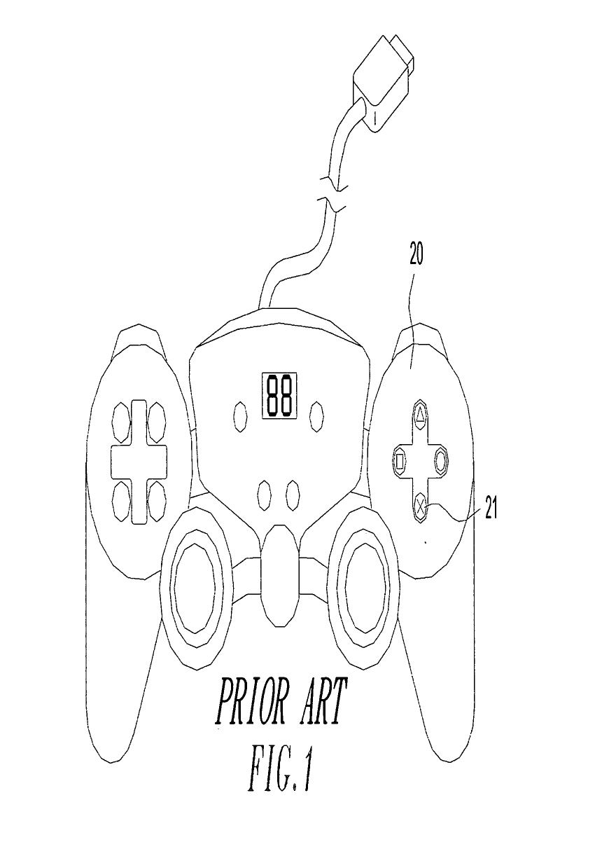

FIG. 2 is a front view schematically illustrating the video game control device of the present invention.

FIG. 3 is a front view schematically illustrating another embodiment of the present invention.

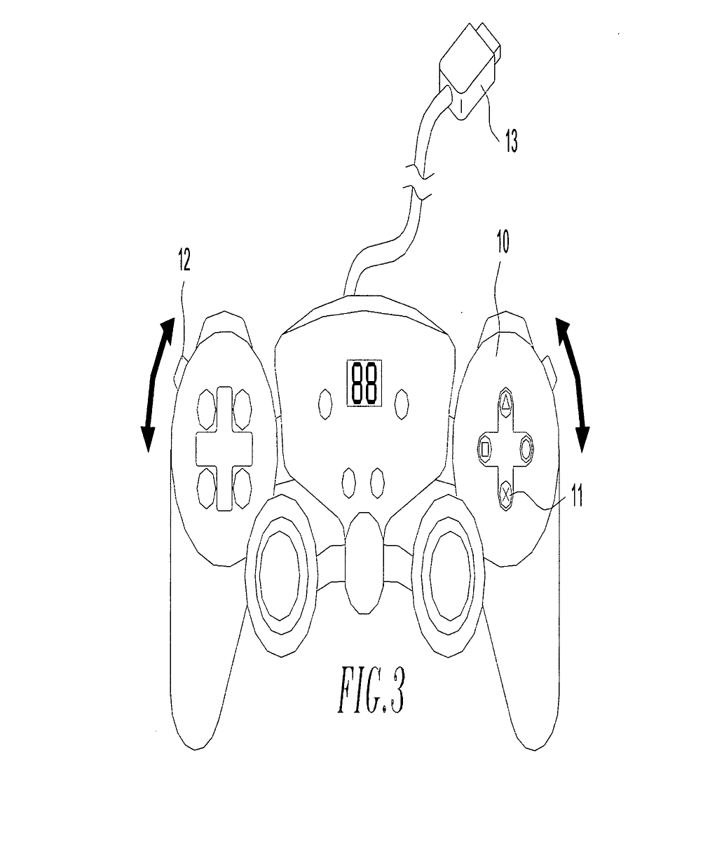

### LIST OF REFERENCE NUMERALS

| | | | |
|---|---|---|---|
| 10 | Control device | 20 | Control device |
| 11 | Control key set | 21 | Control key set |
| 12 | Speedy control key | 13 | Connector |

### DETAILED DESCRIPTION OF THE PREFERRED EMBODIMENT

The present invention may become more understandable if the following description is read with reference to the drawings.

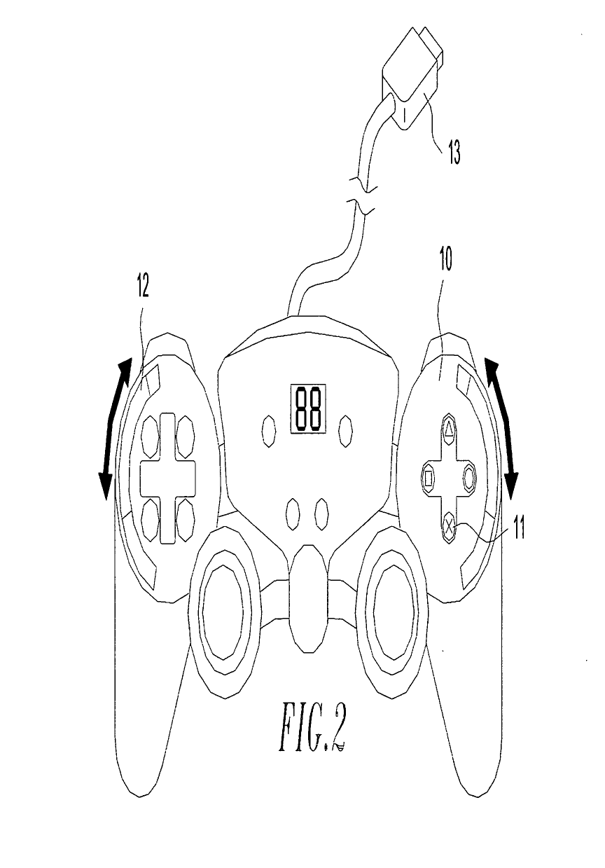

FIG. 2 illustrates the control device of the present invention. As illustrated in FIG. 2, the control device 10 of the present invention comprises a control key set 11, at least one speedy control key 12 and a connector 13. Each speedy control key 12 is disposed on the left side or the right side of the control device 10 so as to allow a user's thumb to reach the speedy control key 12 easily. Each speedy control key 12 has an arcuate shape and may be operated like a steering wheel. Alternatively, each speedy control key 12 is disposed on the right or left side wall of the control device 10 so as to allow a user's index finger to reach the speedy control key 12 easily. Also, one speedy control key 12 may be disposed on the left side of the control device 10 and another speedy control key 12 may be disposed on the right side of the control device 10; furthermore, either of the two speedy control keys 12 may be given different functions.

Each speedy control key 12 may be moved forwards and rearwards as well as may be pressed. In addition, each speedy control key 12 may return to its former position automatically. Each speedy control key 12 may be programmed through hardware or a software program, and the functions so programmed or set may be stored in the control device 10. For example, the forward movement of the speedy control key 12 corresponds acceleration; the rearward movement of the speedy control key 12 corresponds deceleration or braking; the downward movement of the speedy control key 12 (when the key 12 is being pressed) corresponds the engagement of a hand-brake; the speedy control key 12 may return to its former position automatically after a forward movement, a rearward movement or a downward movement. The control device 10 of the present invention may be used for any type of car racing game after the control device 10 is connected the corresponding game machine or computer. With the control device of the present invention, a user only has to use one hand to play a video game. Of course, he may also use both of his hands; in this case, a video game may become more enjoyable.

A connector 13 is disposed on the underside of the control device 10 and may be connected with a computer or a video game machine. The connector 13 may be an ordinary connector in the forms of USB, IEEE1394, RS232 and other forms. Also, the connector 13 may be of wireless connection in the forms of WI-FI, Bluetooth, RF, infrared and other wireless forms. The functions of each speedy control key 12 may be set according to the unique characteristics of a certain type of game.

In conclusion, the control device of the present invention has at least one speedy control key 12, which may be operated like a steering wheel. Also, the functions of each speedy control key 12 may be set by hardware or software according to the unique characteristics of a certain type of game. Hence, the control device of the present invention has a plurality of functions.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A video game control device with speedy control key(s), characterized in that:
at least one speedy control key having a plurality of functions is disposed on the left side or the right side of the front surface of the control device so as to allow a user's thumb to reach the speedy control key easily.

2. The video game control device with speedy control key(s) as in claim 1, wherein the two speedy control keys are disposed on the right side wall and the left side wall, respectively, of the control device, and either speedy control key may be given different functions.

3. The video game control device with speedy control key(s) as in claim 1, wherein the functions of either speedy control key may be set through a software program.

4. The video game control device with speedy control key(s) as in claim 1, wherein the functions of either speedy control key may be set through hardware.

5. The video game control device with speedy control key(s) as in claim 1, wherein either speedy control key has an arcuate shape and may be operated like a steering wheel.

6. The video game control device with speedy control key(s) as in claim 1, wherein either speedy control key may return to its former position automatically.

7. The video game control device with speedy control key(s) as in claim 1, wherein either speedy control key is disposed on the right side or the left side on the front surface of the control device or the right side wall or the left side wall of the control device so as to allow a user's thumb or index finger to reach the speedy control key easily.

8. The video game control device with speedy control key(s) as in claim 1, wherein either speedy control key may be pressed and such downward movement corresponds to a certain function.

9. The video game control device with speedy control key(s) as in claim 1, wherein the control device has at least one connector.

10. The video game control device with speedy control key(s) as in claim 9, wherein the connector may be connected with a computer or a video game machine and may be an ordinary connector in the forms of USB, IEEE1394, RS232 and other forms.

11. The video game control device with speedy control key(s) as in claim 9, wherein the connector may be of wireless connection in the forms of WI-FI, Bluetooth, RF, infrared and other wireless forms.
